(19) United States
(12) Patent Application Publication
(10) Pub. No.: US 2015/0036233 A1
(43) Pub. Date: Feb. 5, 2015

(54) Lifeguard Assistant

(71) Applicant: Demond Hill, Trotwood, OH (US)

(72) Inventor: Demond Hill, Trotwood, OH (US)

(21) Appl. No.: 14/183,336

(22) Filed: Feb. 18, 2014

Related U.S. Application Data
(60) Provisional application No. 61/850,510, filed on Feb. 15, 2013.

(51) Int. Cl. G02B 5/09; B63C 9/00

(52) U.S. Cl. CPC G02B 5/09; B63C 9/00
USPC 359/866

(57) ABSTRACT

My invention and device (non-electronic “at this time”) and all plastic with mirrors), the “Lifeguard Assist.,” short for Lifeguard Assistant, assists the lifeguard from all of these factors listed above. From the screen on top of the pool (the device can float in the water or attach to pool side), the Lifeguard Assist. is pointed to the bottom of the swimming pool of your zone you are covering, allows you to see the bottom of the pool despite all of the factors listed above. Mirror are used to reflect the area of the pool that you want to see the bottom of or clear of. The invention floats. It can be then be made with mirrors going all around it so no matter where it floats you can see the pool area from where the lifeguard is sitting or standing.

What does this invention do? It is designed to save human lives from drowning in water. This device can be used in spa tubs, swimming pools, lakes, on water front beaches, and anywhere people bath or swim in water. This device aids the lifeguard. A person drowns in water because they go under water undetected by the lifeguard because the lifeguard is distracted for whatever reason from watching the patrons in the water; the water is murky (because of the bathers oils/lotions and/or dirt of swimmers) and you can't see through the water nor to the bottom of the pool; the sun is glaring on the water not allowing the lifeguard to see the bottom of the swimming pool; the succumbed swimmer's body blends in with the bottom dark markings or lane line paintings on the swimming pool floor; there are a lot of swimmers swimming in the pool, covering the surface of the water in the pool; and these are the reasons why the swimmer/bather goes underwater undetected by the lifeguard.

When a swimmer or bather goes under water undetected by the lifeguard, this device gives the swimmer/bather another chance of life. The lifeguard at one time was districted and missed the individual going under, when he looks back at the “Lifeguard Assistant” and looks through the view screen, he/she see the individual succumbed under water and then is able to save the individual. The invention gives the lifeguard a clear goggle view of the bottom of the pool (despite all of the causes mentioned above) from where the lifeguard is standing on duty or wherever he is sitting, depending on wherever he positions the “Lifeguard Assistant.”

What does this invention do? It is designed to save human lives from drowning in water. This device can be used in spa tubs, swimming pools, lakes, on water front beaches, and anywhere people bath or swim in water. This device aids the lifeguard. A person drowns in water because they go under water undetected by the lifeguard because the lifeguard is distracted for whatever reason from watching the patrons in the water; the water is murky (because of the bathers oils/lotions and/or dirt of swimmers) and you can't see through the water nor to the bottom of the pool; the sun is glaring on the water not allowing the lifeguard to see the bottom of the swimming pool; the succumbed swimmer's body blends in with the bottom dark markings or lane line paintings on the swimming pool floor; there are a lot of swimmers swimming in the pool, covering the surface of the water in the pool; and these are the reasons why the swimmer/bather goes underwater undetected by the lifeguard. When a swimmer or bather goes under water undetected by the lifeguard, this device gives the swimmer/bather another chance of life. The lifeguard at one time was districted and missed the individual going under, when he looks back at the “Lifeguard Assistant” and looks through the view screen, he/she see the individual succumbed under water and then is able to save the individual. The invention gives the lifeguard a clear goggle view of the bottom of the pool (despite all of the causes mentioned above) from where the lifeguard is standing on duty or wherever he is sitting, depending on wherever he positions the “Lifeguard Assistant.”

My invention and device(non-electronic “at this time”) and all plastic with mirrors), the “Lifeguard Assist.,” short for Lifeguard Assistant, assists the lifeguard from all of these factors listed above. From the screen on top of the pool (the device can float in the water or attach to pool side), the Lifeguard Assist. is pointed to the bottom of the swimming pool of your zone you are covering, allows you to see the bottom of the pool despite all of the factors listed above.

This device gives you a “goggle view” of the bottom of the pool. For example when you swimming underwater, you can see what going on, but it is blurred. You vision under water becomes very clear if your swimming under water with goggles on. You are able to see everything crystal. The “Lifeguard Assist.” will give you that goggle view while you are in your lifeguard chair just by looking down at the screen of the “Lifeguard Assist.” You will be able to see an inactive body laying at the bottom of the pool and rescue the victim before it's too late.

You only have a 6 minute window to rescue somebody that has stopped breathing. Even though the lifeguard on duty had been distracted for a minute and didn't notice the panic victim go under water because he/she wasn't able to call for help. With the “Lifeguard Assist.,” once the lifeguard become undistracted and continues to scan his zone, which includes looking at the view screen of the “Lifeguard Assist.” he will [clearly] see the unconscious victim at the bottom of the pool.

The Lifeguard Assist.” enables the lifeguard on duty to [recover] from a distraction, or a missed opportunity whatever the reason, to save a person's life in time.

### BRIEF DESCRIPTION

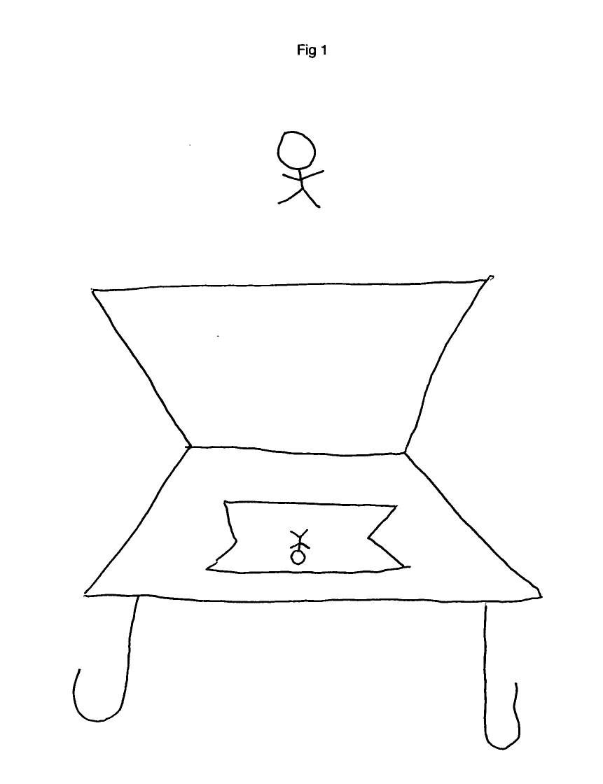

FIG. 1. The invention gives you a swimming pair of googles view of the bottom of the swimming pool to assist the lifeguard on duty so he/she can see the bottom of the pool if a swimmer becomes submerged unnoticed.

### BACKGROUND

I am a lifeguard. I have been a lifeguard for four years. I am also a lifeguard instructor through the American Red Cross Association. So many people, children especially, drown each day from swimming pool drownings. The reason this occurs is because the swimmer goes underwater undetected and when they are discovered, it's too late. This device give a person a second chance of life.

Because of situations described above where a person is not seen submerged under the water the first time, the “Lifeguard Assistant” can assistant the lifeguard and in turn the victim, because the lifeguard can look through the view finder screen and see the person underwater fighting for dear life. Even if that succumbed person was to go unconscious, they are still able to be resuscitated in time because of the invention.

1. My claim and invention is unique because there is no other device/invention like it that is used to prevent and/or discover a person who is about to loose their life by drowning in water. This is a device that is partially under the water and partially above the water. This device can be either floating in the water with the view in the sight of the lifeguard or clipped to the edge of the pool where it is stationary and position where the lifeguard wants it.
